(19) United States
(12) Patent Application Publication
(10) Pub. No.: US 2014/0218291 A1
(43) Pub. Date: Aug. 7, 2014

(54) ALIGNING VIRTUAL CAMERA WITH REAL CAMERA

(71) Applicant: MICROSOFT CORPORATION, Redmond, WA (US)

(72) Inventor: Glen Kirk, Seattle, WA (US)

(73) Assignee: MICROSOFT CORPORATION, Redmond, WA (US)

(21) Appl. No.: 13/762,157

(22) Filed: Feb. 7, 2013

(51) Int. Cl. G06F 3/01

(52) U.S. Cl. CPC G06F 3/011
USPC 345/158

(57) ABSTRACT

Embodiments are disclosed that relate to aligning a virtual camera with a real camera. For example, one disclosed embodiment provides a method comprising receiving accelerometer information from a mobile computing device located in a physical space and receiving first image information of the physical space from a capture device separate from the mobile computing device. Based on the accelerometer information and first image information, a virtual image of the physical space from an estimated field of view of the camera is rendered. Second image information is received from the mobile computing device, and the second image information is compared to the virtual image. If the second image information and the virtual image are not aligned, the virtual image is adjusted.

### BACKGROUND

Augmented reality devices are configured to display virtual objects as overlaid on real objects present in a scene. However, if the virtual objects do not align properly with the real objects, the quality of the user experience may suffer.

### SUMMARY

Embodiments are disclosed that relate to aligning a virtual camera with a real camera. One example method for aligning a virtual camera with a real camera comprises receiving accelerometer information from a mobile computing device located in a physical space and receiving first image information of the physical space from a capture device separate from the mobile computing device. Based on the accelerometer information and first image information, a virtual image of the physical space from an estimated field of view of the camera is rendered. Second image information is received from the mobile computing device, and the second image information is compared to the virtual image. If the second image information and the virtual image are not aligned, the virtual image is adjusted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic example of a physical space for the generation and display of augmented reality images according to an embodiment of the present disclosure.

FIGS. 2 and 3 show views of images of the physical space of FIG. 1 overlaid with virtual images according to an embodiment of the present disclosure.

FIGS. 4 and 5 are flow charts illustrating example methods for aligning a virtual camera with a real camera according to embodiments of the present disclosure.

FIG. 6 schematically shows a non-limiting computing system according to an embodiment of the present disclosure.

### DETAILED DESCRIPTION

Mobile computing devices, such as smart phones, may be configured to display augmented reality images, wherein a virtual image is overlaid on an image of the real world captured by the mobile computing device. However, a mobile computing device may not include sufficient computing resources to maintain display of an accurate virtual image based on the captured real world image. For example, the mobile computing device may be unable to positionally update the virtual image with a sufficiently high frequency to maintain alignment between real world and virtual objects as a user moves through the environment.

Thus, an external computing device may be used to create the virtual images and send them to the mobile computing device for display. The external computing device may receive accelerometer information from the mobile computing device, and also receive depth information from a depth sensor configured to monitor the physical space, in order to determine the location and orientation of the mobile computing device, and create a virtual image using an estimated field of view (e.g. by simulating a “virtual camera”) of the mobile computing device camera.

However, such estimates may be inaccurate, leading to virtual images that do not properly align with real world images. Further, as the external computing device adjusts the view based upon the accelerometer data, alignment errors may compound, such that the apparent alignment gets worse over time.

Thus, embodiments are disclosed herein that relate to facilitating the creation and maintenance of accurately aligned augmented reality images by comparing a virtual image created by a virtual camera of an external computing device to a real world image captured by the mobile computing device. If any deviations are detected between the virtual image and the real world image, the field of view of the virtual camera running on the external computing device may be adjusted (or the virtual image may be otherwise adjusted) to help realign virtual images with the captured real world images.

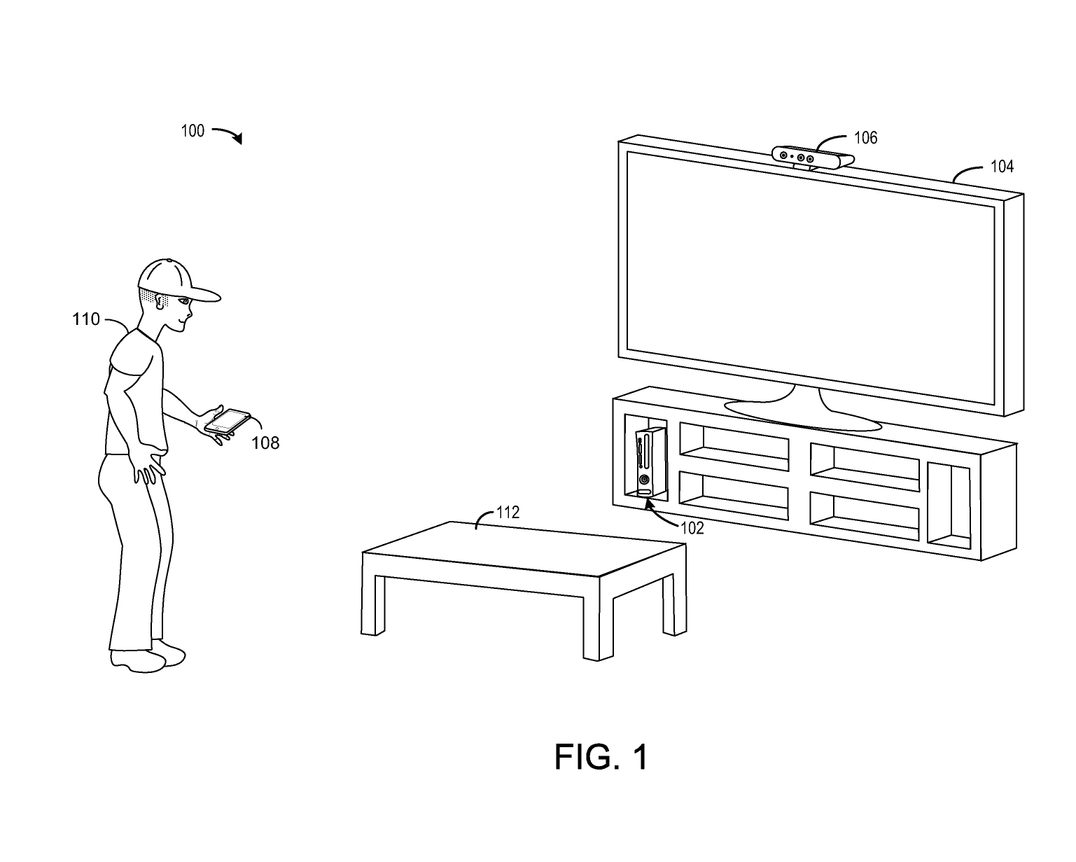

FIG. 1 shows a non-limiting example of an augmented reality display environment 100. In particular, FIG. 1 shows an entertainment system 102 that may be used to play a variety of different games, play one or more different media types, and/or control or manipulate non-game applications and/or operating systems. FIG. 1 also shows a display device 104, such as a television or a computer monitor, which may be used to present media content, game visuals, etc., to users.

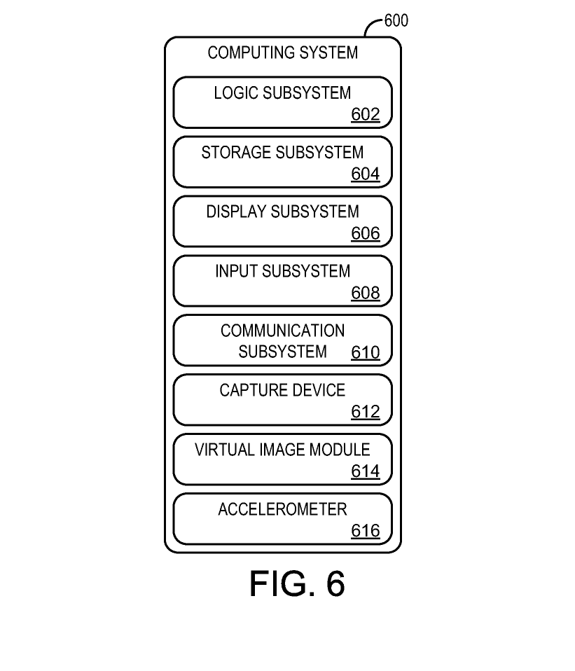

The virtual reality display environment 100 further includes a capture device 106. Capture device 106 may be operatively connected to entertainment system 102 via one or more interfaces. As a non-limiting example, entertainment system 102 may include a universal serial bus to which capture device 106 may be connected. Capture device 106 may be used to recognize, analyze, and/or track one or more persons and/or objects within a physical space. Capture device 106 may include any suitable sensors. For example, capture device 106 may include a two-dimensional camera (e.g., an RBG camera), a depth camera system (e.g. a time-of-flight and/or structured light depth camera), a stereo camera arrangement, one or more microphones (e.g. a directional microphone array), and/or any other suitable sensors. Example depth finding technologies are discussed in more detail with reference to FIG. 6.

In order to image objects within the physical space, a depth camera system may emit infrared light that is reflected off objects in the physical space and received by the depth camera. Based on the received infrared light, a depth map of the physical space may be compiled. The depth camera may output the depth map derived from the infrared light to entertainment system 102, where it may be used to create a representation of the physical space imaged by the depth camera. The depth map may also be used to recognize objects in the physical space, monitor movement of one or more users, perform gesture recognition, etc.

While the embodiment depicted in FIG. 1 shows entertainment system 102, display device 104, and capture device 106 as separate elements, in some embodiments one or more of the elements may be integrated into a common device. For example, entertainment system 102 and capture device 106 may be integrated in a common device.

FIG. 1 also shows a non-limiting example of a mobile computing device 108. Mobile computing device 108 may be configured to wirelessly communicate with entertainment system 102, via a non-infrared communication channel (e.g., IEEE 802.15.x, IEEE 802.11.x, proprietary radio signal, etc.) for example. Mobile computing device 108 also may be configured to communicate via two-way radio telecommunications over a cellular network. Further, mobile computing device 108 may additionally be configured to send and/or receive text communications (e.g., SMS messages, email, etc.). In addition, mobile computing device 108 may include various sensors and output devices, such as a camera, accelerometer, and display. As elaborated below, accelerometer and/or image information from the mobile computing device 108 may be used by entertainment system 102 to help construct a virtual image of the physical space imaged by the camera of mobile computing device 108.

According to embodiments disclosed herein, mobile computing device 108 may present one or more augmented reality images via a display device on mobile computing device 108. The augmented reality images may include one or more virtual objects overlaid on real objects imaged by the camera of mobile computing device 108. In some examples, the virtual images may be created, received, or otherwise obtained by entertainment system 102 for provision to the mobile computing device 108.

In order to align the virtual images as closely as possible to the real objects imaged by mobile computing device 108, entertainment system 102 may estimate a field of view of the camera of mobile computing device 108 via a virtual camera. To determine the estimated field of view of mobile computing device 108, entertainment system 102 may receive depth and/or other image information from capture device 106 of the physical space including mobile computing device 108. Additionally, entertainment system 102 may receive accelerometer information from mobile computing device 108. The image information from capture device 106 and the accelerometer information may be used by entertainment system 102 to determine an approximate location and orientation of mobile computing device 108. Further, if mobile computing device 108 is moving within the physical space, the image information and accelerometer information may be used to track the location and orientation of mobile computing device 108 over time. With this information, a field of view of the camera of mobile computing device 108 may be estimated by the external computing device virtual camera over time based on the location and orientation of mobile computing device 108.

More particularly, entertainment system 102 may create, via depth information from capture device 106, a 2-D or 3-D model of the physical space from the estimated perspective of the mobile computing device 108. Using this model, one or more virtual images that correspond to real objects in the physical space may be created by entertainment system 102 and sent to mobile computing device 108. Mobile computing device 108 may then display the virtual images overlaid on images of the physical space as imaged by the camera of mobile computing device 108.

As explained previously, the image information from capture device 106 and the accelerometer information from mobile computing device 108 may be used to track the location and orientation of mobile computing device 108. For example, the accelerometer information may be used to track the location of mobile computing device 108 using dead reckoning navigation. However, each adjustment made by dead reckoning may have a small error in location tracking. These errors may accumulate over time, resulting in progressively worse tracking performance.

In order to correct for the errors present in the location tracking using the accelerometer information, a corrective mechanism may be performed on the entertainment system 102 and/or on the mobile computing device 108. Briefly, a corrective mechanism may include comparing the virtual image created by entertainment system 102 to a frame of image information captured with the camera of mobile computing device 108. Spatial deviations present between the two images may be detected, and the virtual image may be adjusted to align the two images.

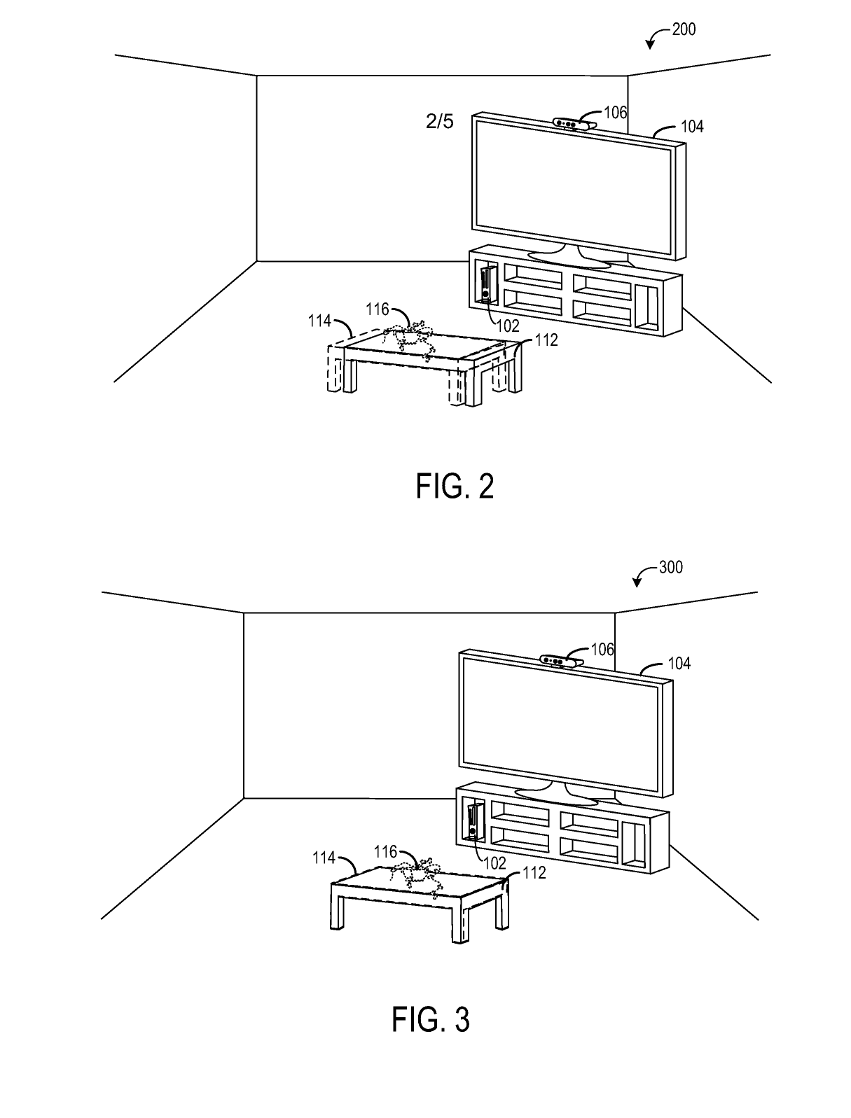

FIG. 2 shows an example of an unaligned augmented reality image 200 as displayed on the display of mobile computing device 108. Unaligned augmented reality image 200 captures a view of the physical space illustrated in FIG. 1 as imaged by the camera of mobile computing device 108. As such, entertainment system 102, display device 104, capture device 106, and table 112 are present as real objects in the image. Additionally, a virtual image created by entertainment system 102 is shown as overlaid on the image of the physical space. The virtual image is depicted as including a virtual table 114 and a virtual plant 116. The virtual table 114 is configured to correspond to real table 112. However, as depicted in FIG. 2, virtual table 114 does not align with real table 112.

Entertainment system 102 or mobile computing device 108 thus may determine the deviation between the virtual image and the real image, and the virtual image may be adjusted to correct the deviation. For example, the entertainment system 102 may create an adjusted virtual image (e.g. by adjusting an estimated field of view of the virtual camera used to simulate the field of view of the camera of mobile computing device 108) so that the real image and virtual image are aligned. FIG. 3 shows a second augmented reality image 300 where the virtual image has been adjusted to aligned virtual table 114 with real table 112.

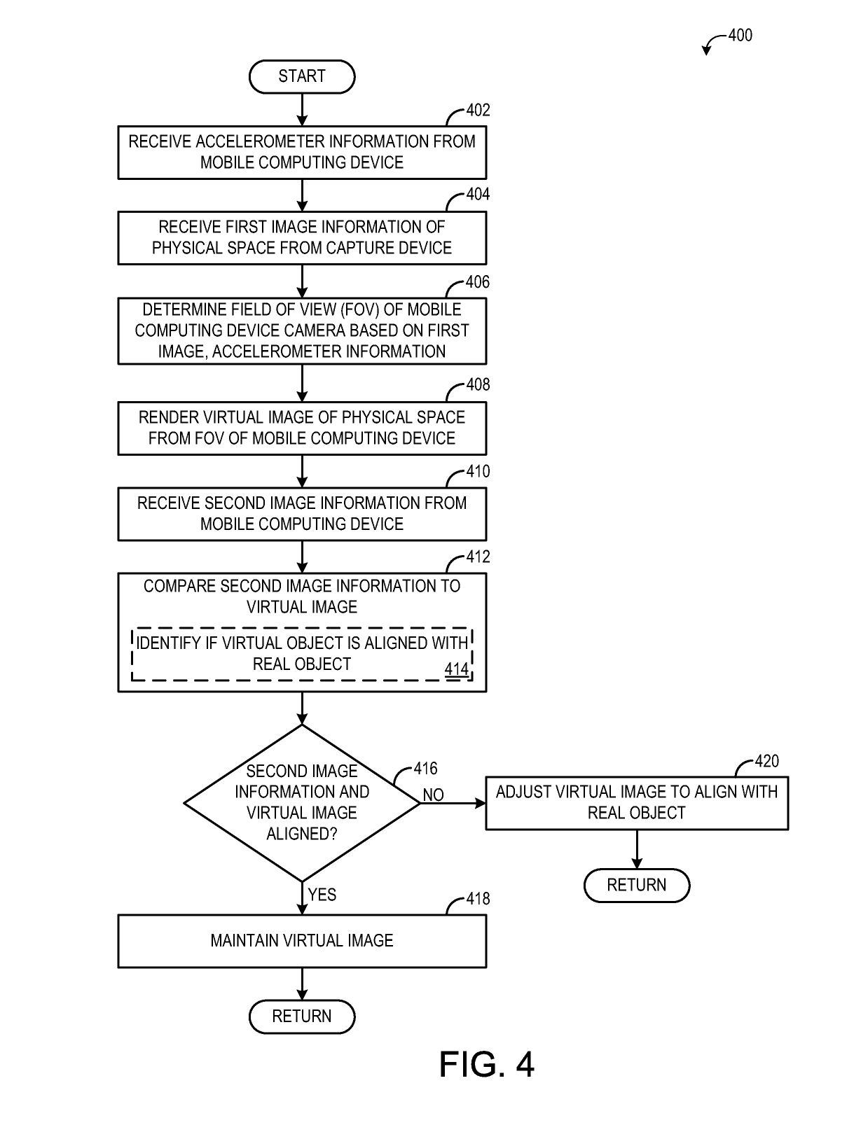

FIG. 4 shows a method 400 for aligning a virtual camera with a real camera. Method 400 may be performed by a computing device, such as entertainment system 102, in communication with a mobile computing device, such as mobile computing device 108. At 402, method 400 includes receiving accelerometer information from a mobile computing device, and at 404, receiving first image information of a physical space. The capture device may be separate from the mobile computing device, and may be integrated with or in communication with the computing device. Capture device 106 of FIG. 1 is a non-limiting example of such a capture device. The image information may include one or more images imaged by a two-dimensional camera (e.g. an RGB camera) and/or one or more images imaged by a depth camera.

At 406, a field of view of the mobile computing device camera is estimated based on the first image information from the capture device and the accelerometer information from the mobile device. At 408, a virtual image of the physical space from the field of view of the mobile computing device is rendered. In some examples, the virtual image may include one or more virtual objects that correspond to real objects located in the physical space.

At 410, second image information is received from the mobile computing device. The second image information may include one or more frames of image data captured by the camera of the mobile computing device. Then, at 412, the second image information is compared to the virtual image. Comparing the second image information to the virtual image may include identifying if a virtual object in the virtual image is aligned with a corresponding real object in the second image information, at 414. Any suitable methods for comparing images may be used. For example, areas of low and/or high gradients (e.g. flat features and edges), and/or other features in the image data from the mobile device, may be compared to the camera image to compare the real object and virtual object. The objects may be considered to be aligned if the objects overlap with less than a threshold amount of deviation at any point, or based upon any other suitable criteria.

At 416, it is determined if the second image information and the virtual image are aligned. The images may be determined to be aligned if the virtual object and the real object are within a threshold distance of one another, as described above, or via any other suitable determination. If the images are aligned, method 400 comprises, at 418, maintaining the virtual image without adjustment. On the other hand, if the images are not aligned, method 400 comprises, at 420, adjusting the virtual image so that the virtual and real images align.

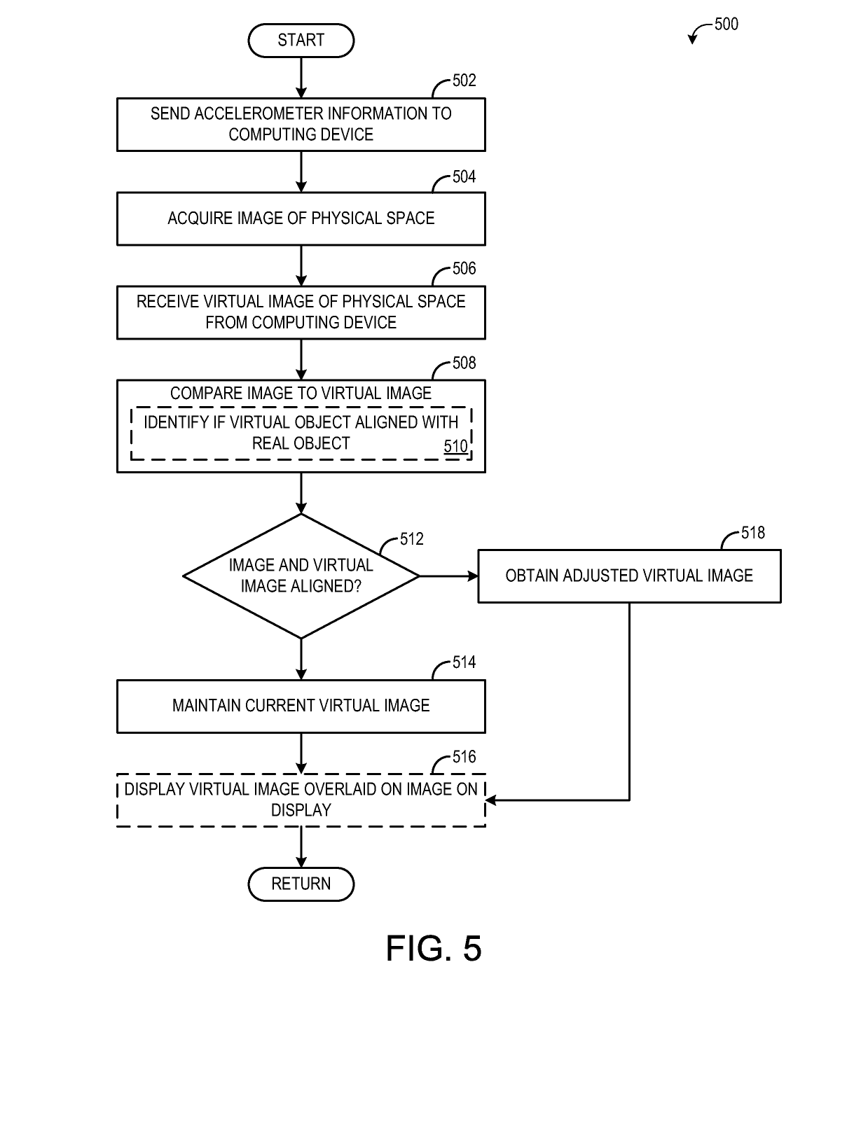

As explained previously, the comparison of the virtual image to the real image captured by the mobile computing device also may be at least partially performed on the mobile computing device. FIG. 5 illustrates a method 500 for aligning a virtual camera with a real camera as performed by the mobile computing device.

At 502, method 500 includes sending accelerometer information to the computing device, and at 504, an image of the physical space is acquired. At 506, a virtual image of the physical space is received from the computing device. The virtual image may be created based upon an estimated field of view of the mobile computing device, as determined by a virtual camera running on the computing device. At 508, the image acquired by the mobile computing device and the virtual image received from the computing device are compared. This may include, at 510, identifying if a virtual object in the virtual image is aligned with the corresponding real object, for example if the virtual object is located within a threshold distance of a corresponding real object in the image, as described above with respect to FIG. 4.

At 512, it is determined whether the image and the virtual image are aligned. If the images are aligned, then method 500 comprises, at 514, maintaining the current virtual image, and at 516, displaying on a display the virtual image overlaid on the image. On the other hand, if it is determined at 512 that the virtual image and the image are not aligned, then method 500 may comprise, at 518, obtaining an adjusted virtual image. Obtaining an adjusted virtual image may include sending a request to the computing device for the adjusted virtual image, wherein the request may include information related to the misalignment of the images, so that the computing device may properly adjust the virtual image and/or the estimated field of view of the mobile computing device. Obtaining an adjusted virtual image also may comprise adjusting the virtual image locally, for example, by spatially shifting the virtual image and/or performing any other suitable processing. Method 500 further may comprise, at 516, displaying the virtual image overlaid on the image.

In some embodiments, the methods and processes described above may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. It will be understood that virtually any computer architecture may be used without departing from the scope of this disclosure. In different embodiments, computing system 600 may take the form of a mainframe computer, server computer, desktop computer, laptop computer, tablet computer, home-entertainment computer, network computing device, gaming device, mobile computing device, mobile communication device (e.g., smart phone), etc.

Computing system 600 includes a logic subsystem 602 and a storage subsystem 604. Computing system 600 may optionally include a display subsystem 606, input subsystem 608, communication subsystem 610, and/or other components not shown in FIG. 6.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 604 includes one or more physical devices configured to hold data and/or instructions executable by the logic subsystem to implement the methods and processes described herein. When such methods and processes are implemented, the state of storage subsystem 604 may be transformed—e.g., to hold different data.

Storage subsystem 604 may include removable media and/or built-in devices. Storage subsystem 604 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices.

It will be appreciated that storage subsystem 604 includes one or more physical devices. However, in some embodiments, aspects of the instructions described herein may be propagated by a pure signal (e.g., an electromagnetic signal, an optical signal, etc.) via a communications medium, as opposed to a storage medium. Furthermore, data and/or other forms of information pertaining to the present disclosure may be propagated by a pure signal.

In some embodiments, aspects of logic subsystem 602 and of storage subsystem 604 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The term “module,” may be used to describe an aspect of computing system 600 implemented to perform a particular function. In some cases, a module may be instantiated via logic subsystem 602 executing instructions held by storage subsystem 604. It will be understood that different modules may be instantiated from the same application, service, code block, object, library, routine, API, function, etc. Likewise, the same module may be instantiated by different applications, services, code blocks, objects, routines, APIs, functions, etc. The term “module” may encompass individual or groups of executable files, data files, libraries, drivers, scripts, database records, etc.

When included, display subsystem 606 may be used to present a visual representation of data held by storage subsystem 604. This visual representation may take the form of a graphical user interface (GUI). As the herein described methods and processes change the data held by the storage subsystem, and thus transform the state of the storage subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or storage subsystem 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic , and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

Computing system 600 may be operatively coupled to a capture device 612. Capture device 612 may include an infrared light and a depth camera (also referred to as an infrared light camera) configured to acquire video of a scene including one or more human subjects. The video may comprise a time-resolved sequence of images of spatial resolution and frame rate suitable for the purposes set forth herein. As described above with reference to FIG. 1, the depth camera and/or a cooperating computing system (e.g., computing system 600) may be configured to process the acquired video to identify a location and/or orientation of a mobile computing device present in an imaged scene.

The nature and number of cameras may differ in various depth cameras consistent with the scope of this disclosure. In general, one or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the surface imaged by that pixel. ‘Depth’ is defined as a coordinate parallel to the optical axis of the depth camera, which increases with increasing distance from the depth camera.

In some embodiments, the depth camera may include right and left stereoscopic cameras. Time-resolved images from both cameras may be registered to each other and combined to yield depth-resolved video.

In some embodiments, a “structured light” depth camera may be configured to project a structured infrared illumination comprising numerous, discrete features (e.g., lines or dots). A camera may be configured to image the structured illumination reflected from the scene. Based on the spacings between adjacent features in the various regions of the imaged scene, a depth map of the scene may be constructed.

In some embodiments, a “time-of-flight” depth camera may include a light source configured to project a pulsed infrared illumination onto a scene. Two cameras may be configured to detect the pulsed illumination reflected from the scene. The cameras may include an electronic shutter synchronized to the pulsed illumination, but the integration times for the cameras may differ, such that a pixel-resolved time-of-flight of the pulsed illumination, from the light source to the scene and then to the cameras, is discernible from the relative amounts of light received in corresponding pixels of the two cameras.

Capture device 612 may include a visible light camera (e.g., color). Time-resolved images from color and depth cameras may be registered to each other and combined to yield depth-resolved color video. Capture device 612 and/or computing system 600 may further include one or more microphones.

Computing system 600 may also include a virtual image module 614 configured to create virtual images based on image information of a physical space. For example, virtual image module 614 may receive information regarding a field of view of capture device 612 or of an external camera and create a virtual image based on the image information. The virtual image may be configured to be overlaid on real images captured by capture device 612 and/or the external camera. Computing system 600 may also include an accelerometer 616 configured to measure acceleration of the computing system 600.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. On a computing device, a method for aligning a virtual camera with a real camera, comprising:
receiving accelerometer information from a mobile computing device located in a physical space;
receiving first image information of the physical space from a capture device separate from the mobile computing device;
based on the accelerometer information and first image information, rendering a virtual image of the physical space from an estimated field of view of the camera;
receiving second image information from the mobile computing device;
comparing the second image information to the virtual image; and
if the second image information and the virtual image are not aligned, adjusting the virtual image.

2. The method of claim 1, wherein the virtual image includes a virtual object that corresponds to a real object present in the physical space.

3. The method of claim 2, wherein comparing the second image information to the virtual image comprises determining if the object in the virtual image is located within a threshold distance of the corresponding real object in the second image information.

4. The method of claim 3, further comprising if the object in the virtual image is not located within the threshold distance of the corresponding real object in the second image information, then adjusting the virtual image.

5. The method of claim 1, further comprising determining a location and orientation of the camera based on the accelerometer information and the first image information in order to determine the estimated field of view of the camera, and wherein the virtual image is based on the estimated field of view of the camera.

6. The method of claim 1, wherein adjusting the virtual image further comprises adjusting the estimated field of view of the camera.

7. The method of claim 1, further comprising, if the second image information and the virtual image are aligned, not adjusting the virtual image.

8. On a mobile computing device, a method for aligning a virtual camera with a real camera, comprising:
sending accelerometer information to a computing device;
acquiring an image of a physical space;
receiving a virtual image of the physical space from the computing device;
comparing the image to the virtual image; and
if the image information and the virtual image are not aligned, obtaining an adjusted virtual image.

9. The method of claim 8, further comprising, on the computing device, using the accelerometer information to determine a location and/or orientation of the mobile device.

10. The method of claim 8, wherein the virtual image includes a virtual object that corresponds to a real object present in the physical space.

11. The method of claim 10, wherein comparing the image to the virtual image comprises comparing a location of the virtual object to a location of the real object in the image.

12. The method of claim 11, wherein if the location of the virtual object is not aligned with the location of the real object, then obtaining the adjusted virtual image.

13. The method of claim 11, wherein if the location of the virtual object is aligned with the location of the real object, then not obtaining the adjusted virtual image.

14. The method of claim 8, wherein obtaining the adjusted virtual image comprises sending a request to the computing device for the adjusted virtual image.

15. The method of claim 8, wherein obtaining the adjusted virtual image comprises adjusting the virtual image on the mobile computing device.

16. A storage device comprising instructions executable by a logic subsystem to:
receive accelerometer information from a mobile computing device located in a physical space;
receive first image information of the physical space from a capture device separate from the mobile computing device;
based on the accelerometer information and first image information, determine an estimated field of view of a camera on the mobile computing device;
render a virtual image based upon the physical space from the estimated field of view of the camera;
receive second image information from the mobile computing device;
identify if an object in the virtual image is aligned with a corresponding object in the second image information; and
if the object in the virtual image is not aligned with the corresponding object in the second image information, then adjust the virtual image to align the object in the virtual image with the corresponding object in the second image information.

17. The storage device of claim 16, wherein the instructions are further executable to, if the object in the virtual image is aligned with the corresponding object in the second image information, not adjust the virtual image.

18. The storage device of claim 16, wherein the instructions are further executable to determine a location and orientation of the camera based on the accelerometer information and first image information in order to determine the estimated field of view of the camera.

19. The storage device of claim 16, wherein the instructions are further executable to adjust the estimated field of view of the camera if the object in the virtual image is not as aligned with the corresponding object in the second image information.

20. The storage device of claim 16, wherein the first image information comprises depth image information.
